(19) United States
(12) Patent Application Publication
(10) Pub. No.: US 2006/0117297 A1
(43) Pub. Date: Jun. 1, 2006

(54) Device and method for controlling at least one system component of an information system

(76) Inventor: Holger Janssen, Hessisch Oldendorf (DE)

Correspondence Address: KENYON & KENYON LLP, ONE BROADWAY, NEW YORK, NY, 10004, US

(21) Appl. No.: 10/524,911

(22) PCT Filed: Jun. 17, 2003
(86) PCT No.: PCT/DE03/02008

§ 371 Date: Sep. 26, 2005

(30) Foreign Application Priority Data
Aug. 24, 2002 (DE) 102 38 936.5

(51) Int. Cl. G06F 9/44

(52) U.S. Cl. 717/120

(57) ABSTRACT

A device and a method for controlling a system component of an information system having at least one sensor and at least one processing unit are provided. A control unit uses information from the system component and controls the configuration of the sensor and processing unit while the information system is operating.

### FIELD OF THE INVENTION

The present invention relates to a device and method for controlling at least one system component of an information system located in a motor vehicle.

### BACKGROUND INFORMATION

Information systems in today's motor vehicles include a multitude of system components. Sensors are an important part of these systems. Sensors obtain information about the motor vehicle itself and its environment. Besides, processing units are a further element of the information systems in motor vehicles. The processing units interpret the sensor information and forward the data to further system components. An indicating instrument, such as the speedometer, is an example of such a further system component.

In motor vehicles, image sensor systems are used to monitor the environment of the vehicle or the vehicle interior. For example, the image sensor systems are planned to be used in driver assistance systems. In particular, image sensor systems can be used to automatically control the distance of the motor vehicle from a vehicle ahead. In the vehicle interior, image sensor systems are intended to be used to control the release of airbags. Here, the image sensor system can be used to monitor the seat occupancy.

Today's information systems in motor vehicles have the feature that the information is processed according to fixed rules and at a constant processing speed. There is no configuration of individual system components while the information system is operating.

### SUMMARY

The device and method according to the present invention for controlling at least one system component of an information system allow the configuration of at least one system component to be controlled by at least one control unit during operation. In the process, information from at least one system component is used in an advantageous manner. The information-providing system component includes at least one first system component which collects information about the environment of the system, and/or at least one second system component which processes at least part of the information collected by the at least one first system component. In particular, the device and method according to the present invention make it possible to control the configuration of at least one system component of an information system in a motor vehicle; the at least one control unit using, for example, information from at least one sensor and/or at least one processing unit. In addition or alternatively, it is possible to use information from vehicle components, for example, to obtain information about the state of the vehicle. Advantageously, configuration control is performed while the system and/or vehicle is/are operating. In particular, the configuration does not interfere, for example, with the acquisition of the image data in an image sensor system or the subsequent processing of the acquired data.

Advantageously, the controlled system component is the at least one first system component and/or the at least one second system component. In particular, in motor vehicles, the device and method described below make it possible to control the configuration of, for example, at least one sensor representing the first system component, and/or to control the configuration of, for example, at least one processing unit representing the second system component. By controlling the configuration of at least one image sensor system, the method described below advantageously allows the temporal and spatial resolution of the image data to be adapted by the control unit. If the amount of image data is increased by controlling the at least one image sensor system, the performance of the at least one image processing unit is adapted at the same time.

Advantageously, at least one control unit is used which controls the configuration of the hardware and/or the configuration of the software of at least one system component. In particular, in information systems in motor vehicles having at least one sensor and at least one processing unit, the device and method advantageously allow configuration of the software within the at least one processing unit. Thus, for example, different algorithms requiring different computing powers can be used in different situations. Besides, the method and device advantageously allow the hardware and/or software of a sensor to be configured, for example, by changing the sensitivity as a function of the situation.

It is advantageous to use at least one control unit that controls the information processing speed of at least one system component. In information systems in motor vehicles having at least one sensor and at least one processing unit, the device and method advantageously make it possible to vary the amount of data actually read by the image sensor system, and thereby to change the resolution of the images. For example, only at least one portion of the image is read out. This advantageously allows the temporal and/or spatial resolution of the recorded images to be increased or reduced.

Advantageously, at least one control unit is used which controls the clock frequency of at least one system component.

In particular, in information systems in motor vehicles having at least one sensor and at least one processing unit, the device advantageously allows the clock frequency of the at least one processing unit to be changed. This makes it possible, in particular, to temporarily increase the clock frequency of the at least one processing unit, which results in an increase in computing power and thus in performance.

Advantageously, at least one control unit is used which monitors the situation of the system and/or the situation of the environment of the system. In particular, in information systems in motor vehicles having at least one sensor and at least one processing unit, the device and method advantageously make it possible to control the configuration of at least one system component, e.g., of at least one image sensor system, and/or of at least one processing unit, taking into account the situation of the system and/or the situation of the environment of the system. Thus, the device and method described below advantageously make it possible to optimize the performance of a processing system for supporting a driver, for example, within the framework of a driver assistance system. This optimization is achieved in that the algorithms available for driver assistance, which are executed in the at least one processing unit, are mapped onto the available hardware depending on the situation in which the driver and/or the vehicle is/are, and in that the software and/or the hardware is/are controlled accordingly. This control represents an adaptation of the algorithms and processing procedures to the requirements of the current situation. This advantageously increases the quality of the driver assistance system, resulting in an increase in traffic safety.

Advantageously, at least one control unit is used which controls the cooling of at least one system component. In particular, in information systems in motor vehicles having at least one sensor and at least one processing unit, the device advantageously allows the cooling to be increased during a reversible overload of the at least one processing unit; the increase in cooling being accomplished by increasing the cooling action, for example, by turning on an additional fan. This advantageously results in a longer overload period without irreversible damage to the processing unit.

Advantageously, at least one control unit is used which controls at least one system component at least temporarily in such a manner that the at least one system component works in overload conditions. In particular, in information systems in motor vehicles having at least one sensor and at least one processing unit, the device advantageously allows the information processing speed of at least one sensor and/or of the at least processing unit to be increased, at least temporarily. This increase is associated with a thermal overload of the system component, which can be reversible or irreversible. In the case of a reversible overload, the information processing speed is increased for a short period of time, i.e., without damaging the sensor and/or the processing unit. However, an irreversible overload results in, for example, thermal destruction of the system component.

In motor vehicles, it is advantageous to use at least one image sensor system and/or at least one radar sensor and/or at least one ultrasound sensor and/or at least one lidar sensor as the at least one first system component. By incorporating a plurality of sensors, it is possible to obtain further data. This leads, for example, to an improvement in the interpretation and assessment of the situation. This increases the reliability of the device described below. In motor vehicles, the use of a plurality of sensors allows the dangerousness of a driving situation to be assessed more accurately because the information sets from the different sensors are processed redundantly.

Advantageously, at least one second system component is used which has at least two hardware partitions. In particular, in information systems in motor vehicles having at least one sensor and at least one processing unit, the device advantageously allows, for example, adaptive distribution of at least one software module among the at least two hardware partitions within the at least one processing unit. This allows the control unit, for example, to temporarily allocate more computing power to a software module within the processing unit. Moreover, the device described below advantageously allows separate internal parameterization of at least one hardware partition by at least one monitoring unit within the at least one processing unit. The parameters that are changed for parameterization are the clock frequency of the processor and/or the clock rate and/or the bandwidth of the communication channels and/or the bandwidth of the memory devices. In this manner, the computing power of the at least one processing unit is advantageously increased or reduced.

Particularly advantageously, the method described below makes it possible that the at least one control unit uses information from at least one system component to establish data describing the current situation of the system and/or the current situation of the system environment; that the at least one control unit carries out a situation assessment; that the at least one control unit establishes a prioritization; and that the at least one control unit controls the configuration of at least one system component while the system is operating. In particular, in information systems in motor vehicles having at least one sensor and at least one processing unit, the method advantageously allows situation-adapted control of the configuration of at least one image sensor system or the at least one processing unit. For example, when a pedestrian wants to cross the street at a small distance ahead of the vehicle, the method described below will recognize the situation and subsequently assess the situation, classifying it as dangerous for the pedestrian. In the next step in this example, the control unit determines the priority of the image processing. The control unit raises the priority of the image processing. Due to the raised image processing priority, first of all, the information processing speed of the image sensor system is increased to be able to detect every movement of the pedestrian in good time and, secondly, the computing power of the image processing algorithms for tracking the pedestrian in the image is increased. Altogether, the method described below leads to a better and reliable detection and tracking of the pedestrian. In a further system, it is then possible, for example, to issue a warning to the driver. Particularly advantageously, the method described below increases traffic safety by recognizing dangerous situations.

Particularly advantageously, the method described below allows prioritization of at least one software module and/or at least one algorithm within the at least one second system component. In particular, in information systems in motor vehicles having at least one processing unit, the devices advantageously makes it possible to prioritize at least one software module by changing the interrupt control within a processing unit implemented by at least one microprocessor.

### BRIEF DESCRIPTION OF THE DRAWINGS

FIG. 1 shows a block diagram of a device for controlling at least one system component of an information system in a motor vehicle.

FIG. 2 is a block diagram of a device for controlling at least one system component of an information system in a motor vehicle.

FIG. 3 illustrates the distribution of software modules among hardware partitions by a prioritization unit.

FIG. 4 depicts the parameterization of hardware partitions by a monitoring unit.

FIG. 5 illustrates the configuration and prioritization of software modules.

FIG. 6 is a flow chart of the method for controlling at least one system component of an information system in a motor vehicle.

### DETAILED DESCRIPTION

FIG. 1 shows an overview block diagram of a device for controlling at least one system component of an information system in a motor vehicle, comprising sensors 10, a processing unit 12, a control unit 14, and a further system 16. Sensors 10 are mounted in and/or on and/or on top of the motor vehicle. The sensors collect information about the motor vehicle and/or the information system and/or the environment of the motor vehicle. The information collected by sensors 10 is transferred to and processed in processing unit 12. The results are transferred to a further system 16. In the preferred exemplary embodiment, control unit 14 uses information from two system components, processing unit 12, and the further system 16. Based on this information, control unit 14 controls the configuration of the further system components of the information system. In the preferred embodiment, these are sensors 10, control unit 12, and the further system 16.

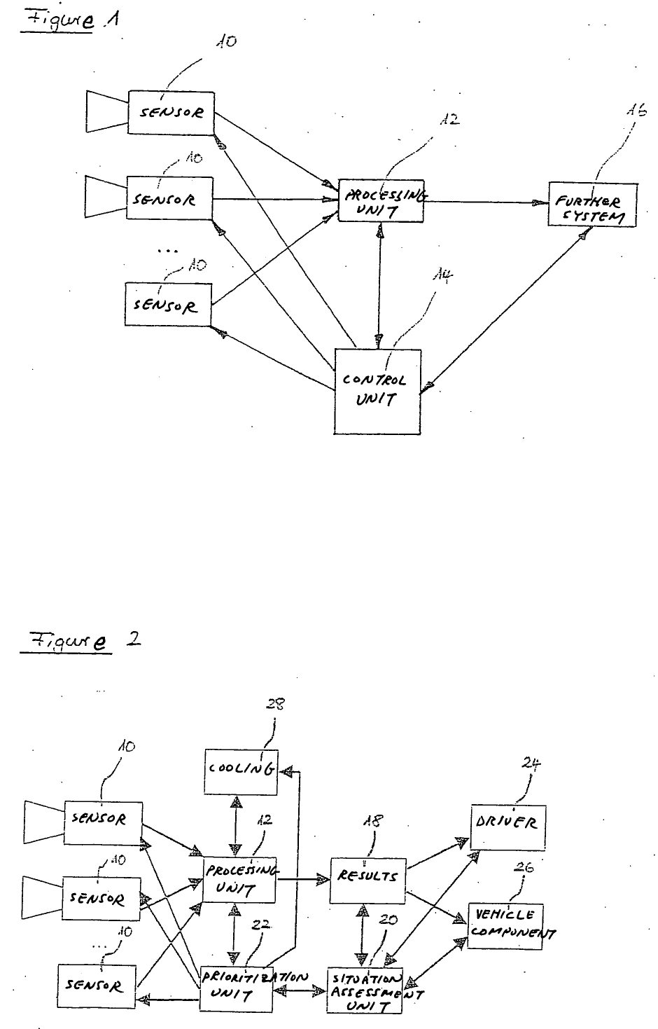

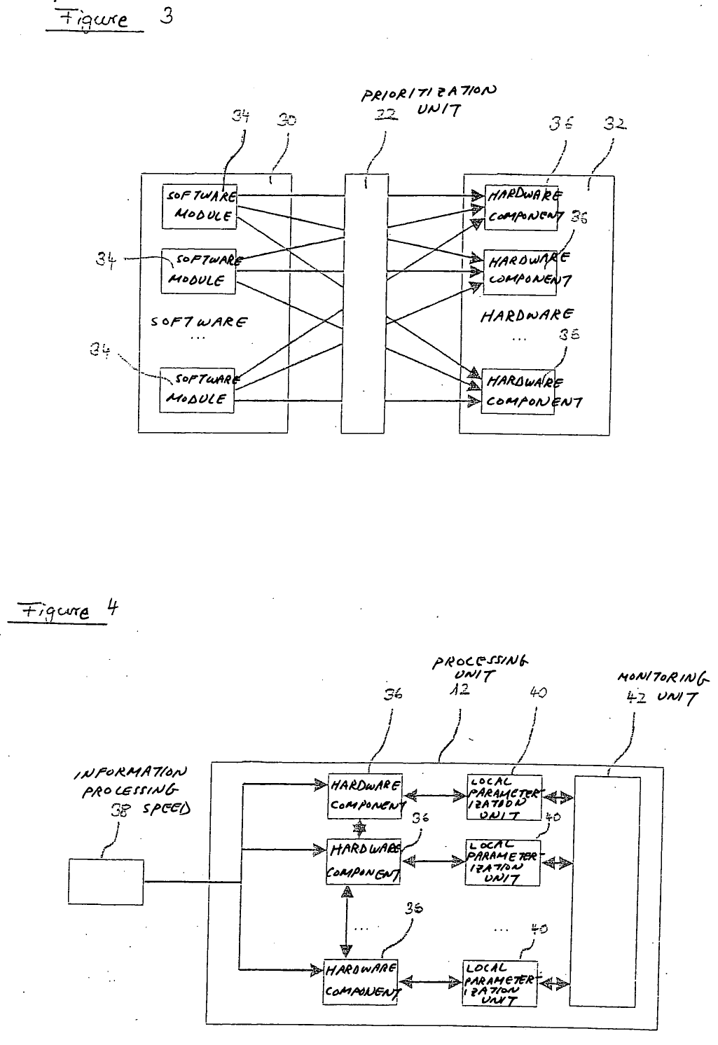

Expanding on the device of FIG. 1, FIG. 2 shows a block diagram of a device for controlling at least one system component of an information system in a motor vehicle. The block diagram shows the system components of a system for adaptive control of the processing procedures of an information system for monitoring the situation in the environment and the interior of a motor vehicle. Information about the situation is collected by sensors 10, which are connected to a processing unit 12 via a signal line. In an example embodiment, two image sensor systems, one radar sensor and three ultrasound sensors are used as sensors 10. In FIG. 2, only three sensors are shown by way of example. The image sensor systems used in the exemplary embodiment are CCD or CMOS cameras. The information from sensors 10 is processed in processing unit 12 and provided to driver 24 and vehicle components 26 as results 18. Driver 24 and vehicle components 26 shown in FIG. 2 are examples of further systems 16 shown in FIG. 1. In FIG. 2, control unit 14 of FIG. 1 is represented by situation assessment unit 20 and prioritization unit 22. Based on results 18 and/or the further information from driver 24 and/or vehicle components 26, a situation evaluation and assessment is generated in situation assessment unit 20. At the same time, the results of the situation assessment can be transmitted to driver 24 and/or vehicle components 26.

Different situations lead to different requirements for processing unit 12 in terms of the algorithms executed in processing unit 12. The different requirements result in different levels of complexity for the different algorithms. Prioritization unit 22 translates the results of the situation assessment into the control of processing unit 12. At the same time, prioritization unit 22 receives information from processing unit 12 about the current utilization thereof. Prioritization unit 22 also influences the current rate at which the data is supplied from sensors 10 to processing unit 12. Besides, prioritization unit 22 also controls the cooling 28 of processing unit 12. As a further function, prioritization unit 22 monitors the system performance, e.g., the degree of utilization of the overall system. Information transfer between the individual system components takes place wirelessly, e.g., by radio and/or light, or via wire. The processing of the information within processing unit 12, situation assessment unit 20, and prioritization unit 22 is performed by programs which are implemented by at least one microprocessor.

FIG. 3 illustrates the control of the configuration of the processing unit by prioritization unit 22 in the exemplary embodiment. FIG. 3 illustrates how software modules 34, i.e., individual programs and/or program steps, of software 30 are mapped by prioritization unit 22 onto hardware components 36, i.e., individual arithmetic units, of hardware 32. Software modules 34 and hardware partitions 36 are part of the processing unit. A single software module 34 can be executed on one or more hardware components 36. It is also possible for one or more software modules 34 to be inactive and not perform any algorithms, which means that they are not assigned any hardware components 36. The control of the distribution of the individual software modules 34 among hardware components 36 is assumed by prioritization unit 22. This allows the required tasks to be prioritized according to the complexity of the current situation. For example, the mapping of software modules 34 is performed by a scheduler. Besides, methods of distributed systems and/or multitasking systems are used.

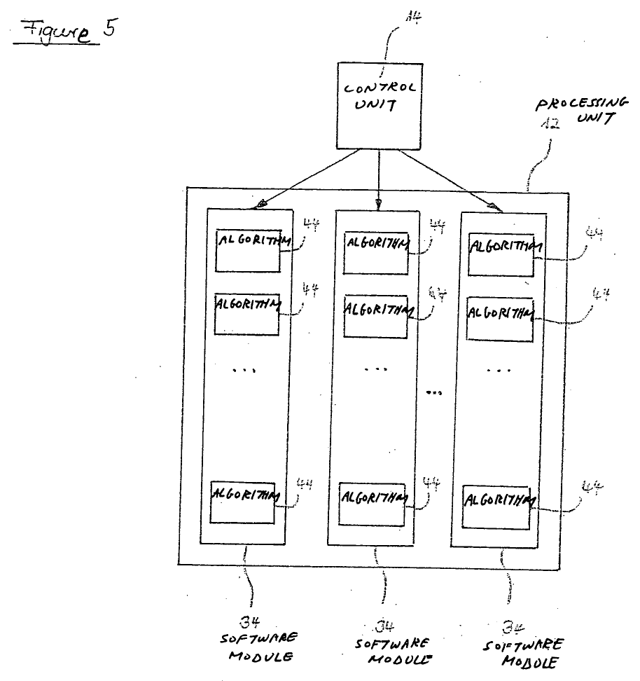

FIG. 4 illustrates the control of the performance of processing unit 12 by selecting an information processing speed 38 defined, for example, by an external clock. This external clock is variable and depends on the current requirements, which are dependent on the complexity of the current environment and state of the vehicle. Information processing speed 38 is passed on to processing modules which, in the example embodiment, are implemented by hardware components 36. Hardware components 36 can be internally parameterized differently from external information processing speed 38. For this purpose, there are a number of local parameterization units 40, which can provide higher or lower performance, depending on the degree of utilization of the respective hardware component 36. The local parameterization by parameterization units 40 is monitored by monitoring unit 42. In the exemplary embodiment, the control of information processing speed 38 and monitoring unit 42 is done by the control unit. Parameterization units 40 control the respective hardware component 36. In the process, parameterization units 40 control the clock rate of the respective hardware component 36 and/or the cooling and/or the bandwidth for communication, and/or parameterization units 40 specify the software to be executed on the respective hardware component 36. Alternatively or additionally, hardware component 36 is internally parameterized by parameterization unit 40. In the process, the use of registers of different width is defined and/or the communication paths between the elements of a hardware component 36 are parameterized and/or the hardware component 36 is optimized for the respective computing task.

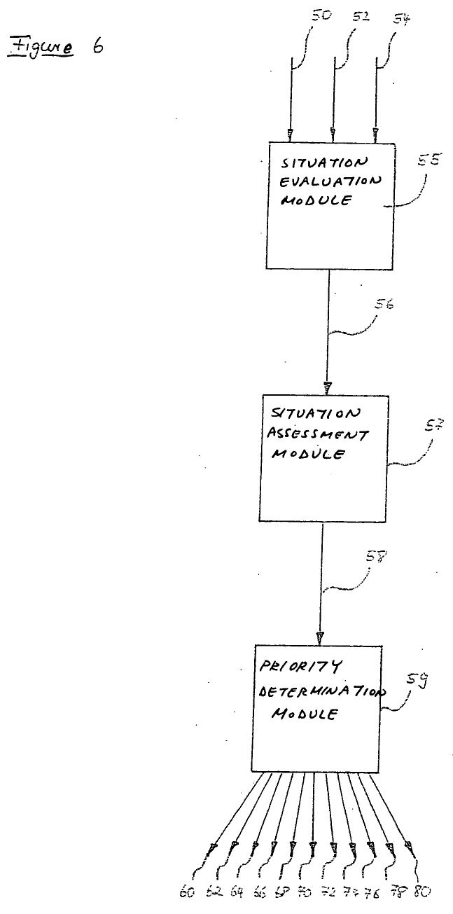

FIG. 5 illustrates the configuration, in particular the prioritization, of software modules 34 and/or algorithms 44 of processing unit 12 by control unit 14. Processing unit 12 is composed of software modules 34, which in turn implement algorithms 44. Control unit 14 configures software modules 34 and/or algorithms 44 by setting parameters. In the exemplary embodiment, software modules 34 and/or algorithms 44 is/are prioritized by control unit 14 by changing the interrupt control within processing unit 12, which is implemented by at least one microprocessor.

FIG. 6 is a flow chart of an exemplary embodiment of the method for controlling at least one system component of an information system in a motor vehicle. Modules 55, 57 and 59 are part of the control unit and, in the exemplary embodiment, take the form of programs of at least one microprocessor. In module 55, a situation evaluation is carried out based on information 50 from the processing unit, information 52 from the driver, and information 54 from the vehicle components. The situation evaluation in module 55 results in situation data 56, which is passed on to module 57 for situation assessment. During situation assessment in module 57, assessed situation data 58 is generated from situation data 56 and passed on to module 59. In module 59, a priority determination takes place. At the same time, module 59 carries out the control of the system components. In the exemplary embodiment, the following variants are available for controlling the configuration of the system components:
distribution of software modules among hardware components in the processing unit 60;
control of the information processing speed of the processing unit 62;
parameterization of hardware components of the processing unit 64;
configuration of the software modules of the processing unit 66;
prioritization of the software modules of the processing unit 68;
configuration of the algorithms of the processing unit 70;
prioritization of the algorithms of the processing unit 72;
control of the cooling of the processing unit 74;
control of the information processing speed of the sensors 76;
selective selection of data from the sensors 78; and
control of vehicle components 80.

The situation evaluation in module 55 is, e.g., the result of the interpretation of the information from the sensors. In the exemplary embodiment, the primary sensors used are imaging sensors, such as video cameras or range imagers. In the exemplary embodiment, the radar sensor and the three ultrasound sensors are secondary sensors. The primary and secondary sensors supply their information to the processing unit, which passes this information on to the control unit. Alternatively or additionally, information from further system components is used. For the purpose of modeling, digital maps are used which contain information about the environment of the motor vehicle. Digital maps are well-suited for situation evaluation (context evaluation). Module 55 uses the information to model the vehicle state, the environment of the motor vehicle, and the system itself. The results of this modeling are, for example:
classification of objects in the vehicle environment, such as a passenger car, truck, tree, adult, child, dog, traffic sign;
modeling of the driving environment, such as the roadway, number of lanes, turning lanes, and intersections;
additional information for assessing the environment, for example, traffic signs, traffic lights, and the condition of the roadway;
determination of the relative speeds and/or the acceleration and/or the distance of all objects from the motor vehicle; and
the turning behavior of other road users.

In addition, the condition of the driver, such as fatigue and/or reaction speed and/or age and/or the taking of medication are also included in the assessment. The behavior of the driver is used in the assessment as well. This information about the condition of the driver is either collected by sensors and/or may be input into the system. By the transmission of information from the vehicle components, the state of the motor vehicle is included in the assessment. In this connection, the exemplary embodiment takes into account, e.g., the proper motion and/or skidding and/or braking and/or tire pressure and/or tire condition and/or roadway parameters and/or braking performance and/or the engine power and/or the traveling speed. The situation of the system, such as the degree of utilization of the processing unit, is also taken into account.

In the exemplary embodiment, module 57 generates assessed situations based on the collected situation data 56, the assessed situations being passed on to subsequent module 59 in the form of assessed situation data 58. Assessed situations are, for example:
accident with motor vehicle is no longer avoidable;
collision with other road users, e.g., pedestrians, is imminent;
driver consequently ignores traffic signs;
driver snakes from side to side in the lane;
high vehicle speeds combined with small distances between vehicles;
traffic jam situation;
city traffic; and
expressway traffic.

Via the situation assessment in module 57, procedures are derived which are used in module 59, for example, to prioritize the processing steps executed in the processing unit.

A general problem is the dangerousness of the situation. A hazard can result, e.g., from objects that are somehow on a collision course with the motor vehicle. Once such objects are detected, the movement behavior of this object is tracked with very high priority. It generally applies that causes that can lead to dangerous situations are monitored and analyzed with high system priority. It is also possible to take high-priority measures that contribute to solving the situation and/or help assist in solving the situation. In the exemplary embodiment, for example, the following points are taken into account in the prioritization in module 59, individually or in combination:
dangerous situation;
complex situation;
clear situation;
type of road, for example, city street, country road, or expressway;
high speeds;
low speeds;
turning, intersections;
large flood of information, for example, in city traffic;
driver condition;
maneuvers initiated by the driver, such as overtaking, braking, or avoidance action;
hazard to persons;
hazard to animals;
unavoidable collision with another object;
accident severity prediction;
total loss; and
risk of injury to passengers and/or other road users.

The behavior of the information system of the exemplary embodiment will be described below by way of example. The information system is located in a passenger car. In an example situation, the driver of the passenger car is traveling outside city limits on a four-lane road with two lanes in each direction, separated by a paved median. The speed limit indicated by the signs is 120 km/h. The road is heavily used by passenger cars, trucks, and motorcycles. The driver is driving in the left lane, i.e., in the passing lane, at a speed of 150 km/h. A motorcycle is traveling in the right lane behind a slow-moving truck. The motorcycle has turned on the left blinker. Module 55 models the state of the driver's vehicle and the state of the adjacent vehicles. In the present case, the system determines the following data: traffic signs indicating a speed limit of 120 km/h, 2 lanes of the roadway in the direction of travel, truck driving ahead at 80 km/h in the right lane, motorcycle driving ahead at 100 km/h with left blinker on, the passenger car's own speed is 150 km/h, driver is fatigued by a five-hour ride. In module 57, an assessed situation is generated from this. The assessed situation identified is as follows: imminent collision with another road user (motorcycle), driver ignores traffic signs (speed limit 120 km/h), expressway traffic. In module 59, finally, a prioritization is carried out. A dangerous situation is identified. The action taken now results in the control of the configuration of the system components. The information processing speed of the image sensor system is increased. At the same time, the software modules for image processing in the processing unit are assigned a higher priority. Moreover, the software modules are configured to allow reliable tracking of the motorcycle as the dangerous situation progresses. At the same time, the image-processing software modules are distributed among a plurality of hardware components of the processing unit.

In the exemplary embodiment, the information system can also be optimized by the control unit by placing an overload on at least one system component. This overload can be reversible if high computing power is used only for a short period of time. In an overload situation, a possible countermeasure is, for example, to use the cooling accordingly. An irreversible overload may result in the destruction of the system and/or of system components. Irreversible destructions can be assigned for particularly high priorities, such as an imminent high risk of injury, dangerous situation, hazard to persons, hazard to children, or when there is a possibility to minimize the imminent damage to motor vehicles. In the exemplary embodiment, provision is made for easy maintenance and diagnosis of system components that can be irreversibly destroyed or reversibly overloaded.

In the exemplary embodiment, the control unit performs a general monitoring function to prevent the information system from becoming unstable. Instability can occur when, due to limited sensory data acquisition, the situation assessment produces an increasingly false assessment of the situation, and global countermovements are not included in the situation assessment. For example, a limitation in the sensory data acquisition leads to information loss in sensing regions which will then no longer be evaluated. In an image sensor system, this can, for example, result in new traffic signs being no longer recognized. This can lead to an incorrect situation assessment, which can lead to instability of the information system.

The above-described device and method are not limited to use in motor vehicles. The device and method according to the present invention can be employed for controlling at least one system component of any information system; at least one first system component collecting information about the environment of the system, and at least one second system component processing at least part of the information collected by the at least one first system component. When using the above-described device and method in applications other than automotive, other situations will occur in the system and in the environment of the system. These new situations need to be taken into account in the situation evaluation and situation assessment. In this context, everything that is not part of the information system itself is subsumed under the term “environment of the system”. In particular, when using the information system in a motor vehicle, the motor vehicle is part of the environment of the system.

In a variant of the method described above, additional sensors may be used. The sensors used there are range-imaging sensors (range imagers) and/or active scanning sensors, such as lidar sensors, and/or other sensors suitable for monitoring and interpreting the environment of a motor vehicle.

In a further variant of the device and method described above, the control unit receives the sensor information directly from the sensors via signal lines, instead of indirectly via the processing unit, as in the exemplary embodiment.

In a variant of the device and method described above, a plurality, for example two to ten, of control units are used. Each of the control units assumes a subfunction. The control units are communicatingly connected to each other, for example, via a bus system. Moreover, the control units form a redundant system to ensure that when one control unit fails, the function thereof is assumed by the other remaining control units. In a further variant of the device and method described above, the control unit can be an integral part of at least one system component. In particular, the control unit can be integrated into the at least one second system component, for example, in the processing unit of the embodiment embodiment.

1-17. (canceled)

18. A device for controlling at least one system component of an information system located in a motor vehicle, comprising:
at least one first system component which collects information about the environment of the system;
at least one second system component which processes at least part of the information collected by the at least one first system component; and
at least one control unit which controls configuration of at least one system component while the system is operating, the least one control unit using information from at least one information-providing system component.

19. The device as recited in claim 18, wherein at least one of:
(a) the at least one information-providing system component includes at least one of the at least one first system component, the at least one second system component, and at least one further system component; and
(b) the at least one controlled system component includes at least one of the at least one first system component and the at least one second system component.

20. The device as recited in claim 19, wherein the at least one control unit controls configuration of at least one of a hardware and a software of at least one system component.

21. The device as recited in claim 19, wherein the at least one control unit controls information processing speed of at least one system component.

22. The device as recited in claim 19, wherein the at least one control unit controls a clock frequency of at least one system component.

23. The device as recited in claim 19, wherein the at least one control unit monitors an environment of the information system, the environment including at least one of a state of the motor vehicle and a state of the information system.

24. The device as recited in claim 19, wherein the at least one control unit controls at least one system component at least temporarily such that the at least one system component operates in an overload condition.

25. The device as recited in claim 19, wherein the at least one first system component is at least one of an image sensor system, a radar sensor, an ultrasound sensor, and a lidar sensor.

26. The device as recited in claim 19, wherein the at least one second system component has at least two hardware components and at least one software module, the at least one software module being distributed between the two hardware components, and wherein the at least one control unit controls the distribution of the software module.

27. The device as recited in claim 19, wherein the at least one second system component has at least one hardware component that is adapted to be parameterized.

28. A method for controlling at least one system component of an information system located in a motor vehicle, comprising:
collecting, using at least one first system component, information about the environment of the system;
processing, using at least one second system component, at least part of the information collected by the at least one first system component;
controlling, by at least one control unit using information from at least one system component, configuration of at least one system component while the system is operating.

29. The method as recited in claim 28, wherein:
the at least one control unit uses information from at least one system component to establish data describing at least one of a current situation of the system and a current situation of the system environment, and wherein the at least one control unit carries out a situation assessment based on the established data.

30. The method as recited in claim 29, wherein the at least one control unit establishes a prioritization based on the situation assessment.

31. The method as recited in claim 29, wherein at least one of:
(a) the at least one information-providing system component includes at least one of the at least one first system component, the at least one second system component, and at least one further system component; and
(b) the at least one controlled system component includes at least one of the at least one first system component and the at least one second system component.

32. The method as recited in claim 29, wherein the at least one control unit controls configuration of at least one of a hardware and a software of at least one system component.

33. The method as recited in claim 29, wherein the at least one control unit controls information processing speed of at least one system component.

34. The method as recited in claim 29, wherein at least one of a software module and a portion of the at least one second system component is prioritized by the at least one control unit.
